(19) United States
(12) Patent Application Publication
(10) Pub. No.: US 2016/0253996 A1
(43) Pub. Date: Sep. 1, 2016

(54) ACTIVATING VOICE PROCESSING FOR ASSOCIATED SPEAKER

(71) Applicant: Lenovo (Singapore) Pte. Ltd., Singapore (SG)

(72) Inventors: Nathan J. Peterson, Durham, NC (US); Russell Speight VanBlon, Raleigh, NC (US); Arnold S. Weksler, Raleigh, NC (US); Rod D. Waltermann, Rougemont, NC (US); John Carl Mese, Cary, NC (US)

(21) Appl. No.: 14/633,524

(22) Filed: Feb. 27, 2015

(51) Int. Cl. G10L 15/22; G06F 3/01; G06F 3/16

(52) U.S. Cl. CPC G10L 15/22; G06F 3/167; G06F 3/015

(57) ABSTRACT

One embodiment provides a method, including, but not limited to: obtaining, from a device physically located on a user, an input indicating the user is speaking; the input being related to a movement of the user; and activating, using a processor, voice processing. Other aspects are described and claimed herein.

### BACKGROUND

Many information handling devices (e.g., smart phones, tablets, smart watches, laptop computers, personal computers, smart televisions, etc.) have voice processing capabilities. Using these voice processing capabilities the information handling device may be able to recognize verbal commands and perform actions based upon the verbal commands.

Activating voice processing for some information handling devices may require a user to provide a manual input. For example, a user may press a button on the information handling device to activate voice processing. In other information handling devices the voice processing may be activated upon receiving a particular word or phrase. For example, an information handling device may associate the phrase “OK, phone” with a command to activate the voice processing. Once the voice processing has been activated, the device may listen to verbal communications and perform actions based upon the vocal command received. For example, a user may say “Call John” and the device may perform the actions associated with calling John.

### BRIEF SUMMARY

In summary, one aspect provides a method, comprising: obtaining, from a device physically located on a user, an input indicating the user is speaking; the input being related to a movement of the user; and activating, using a processor, voice processing.

Another aspect provides an apparatus, comprising: a processor; a memory device that stores instructions executable by the processor to: obtain an input indicating a user is speaking; the input being related to a movement of the user; and activate voice processing.

A further aspect provides a product, comprising: a storage device having code stored therewith, the code being executable by the processor and comprising: code that obtains, from a device physically located on a user, an input indicating the user is speaking; the input being related to a movement of the user; and code that activates voice processing.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of activating voice processing for associated speaker.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Many information handling devices (“devices”) have voice processing capabilities allowing a user to provide verbal commands which cause the device to perform some action associated with the command. One method of activating voice processing on a device requires the user to provide a manual input. The user can then provide a command and the device will perform the actions associated with fulfilling that command. However, requiring manual input to activate the voice processing is cumbersome and decreases the effectiveness and convenience of the voice processing capabilities. For example, one reason a user may wish to use the voice processing on a device is due to safety concerns. For example, if a user is driving and is using the voice processing capabilities of their mobile phone to call a person, having to provide a manual input requires the user to fumble with and possibly look at the phone.

In addition to these issues, the manual input may become confusing. For example, different information handling devices may have different manual input requirements for activating voice processing. For example, a smart phone may require a user to press a button located on the side of the phone, while a tablet may require a user to provide a specific touch screen input. Additionally, inputs between different providers and/or manufacturers of devices may be different. This requires a user to learn and/or know the specific input requirement to activate voice processing for each device that they may use, which can be cumbersome and confusing.

Another method for activating voice processing reduces the amount of manual input required by a user. Rather than requiring a manual input the device listens for a particular phrase to activate the voice processing. Upon receiving this phrase, the device then listens for instructions for performing an action. For example, a user may say “OK, GOOGLE” which may cause the device to activate voice command processing software. GOOGLE is a registered trademark of Google, Inc. in the United States and other countries. When the user then says “remind me to pick up milk at 6 pm” the device may create a reminder. However, this solution may also be confusing in that the user has to know the particular phrase that the device requires in order to activate voice processing. This phrase may be different between devices and manufacturers or operating systems running on the devices.

Additionally, this method requires that the voice processing is always running in the background. The device has to listen to and process all audio data within a location in order to determine whether the particular phrase or command has been received. Not only does this require processing and memory space to be used for analyzing every noise, but having the voice processing running in the background also causes a drain on the battery of the device. In addition to performance issues, this method of listening for a particular command may allow other people to control the device. For example, a user may have a device that responds to a particular phrase and that phrase may be spoken by a person within the same room causing the device to activate the voice command processing and perform some action associated with the next audio data received.

These technical issues present problems for users in that the usability of a device having voice processing capabilities is reduced. In some cases, the user has to provide a manual input to activate the voice processing. This manual input requirement can reduce the effectiveness and convenience of the voice processing. Additionally, this manual input requirement can become cumbersome and confusing and is often times dependent on the device and manufacturer. Devices which respond to a particular phrase or command rather than a manual input also have issues. This type of activation requires that the device be running voice processing at all times in the background in order to react when a particular phrase is received. Additionally, another person can activate the voice processing without the consent of the device owner. If a device had a method of determining when the user of the device is talking and only activating voice processing at this time, the user could be assured that the device would only respond to the user's commands. This would reduce the drain on processing resources and battery life. Additionally, a user would not have to fumble with entering a manual input to activate the voice processing.

Accordingly, an embodiment provides a method of activating voice processing when a user associated with an information handling device is talking. An embodiment may receive an input from an information handling device physically located on a user (e.g., smart watch, Bluetooth headset, smart phone, tablet, etc.), indicating the user is speaking. To detect that a user is speaking an information handling device may use data derived from a movement of the user. For example, a device may use electromyography or vibration data to determine that the user is speaking.

Upon receiving this input, an information handling device may activate voice processing. In one embodiment this activation may occur by one information handling device sending a signal to another information handling device. For example, a Bluetooth headset may detect that the user is speaking and send a signal to the user's smart phone telling the smart phone to activate voice processing. In an alternative embodiment, the device may detect that a user is speaking and may activate the voice processing within the same device. For example, a user may have a smart watch that detects that the user wearing the watch is speaking, which may then activate the watch's voice processing. After activating the voice processing, one embodiment may then receive additional audio data which may then be processed and analyzed to determine if the device should perform some action associated with a command.

The illustrated example embodiments will be best understood by reference to the figures. The following description is intended only by way of example, and simply illustrates certain example embodiments.

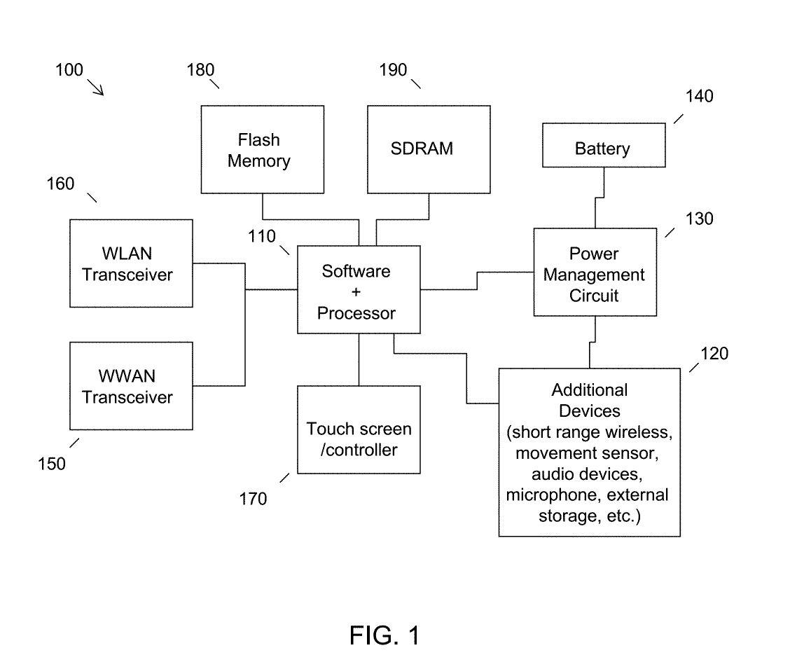

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., sensors for detecting movement such as electromyography or vibration sensors and short range wireless communications. System 100 often includes a touch screen 170 for data input and display/rendering. System 100 also typically includes various memory devices, for example flash memory 180 and SDRAM 190.

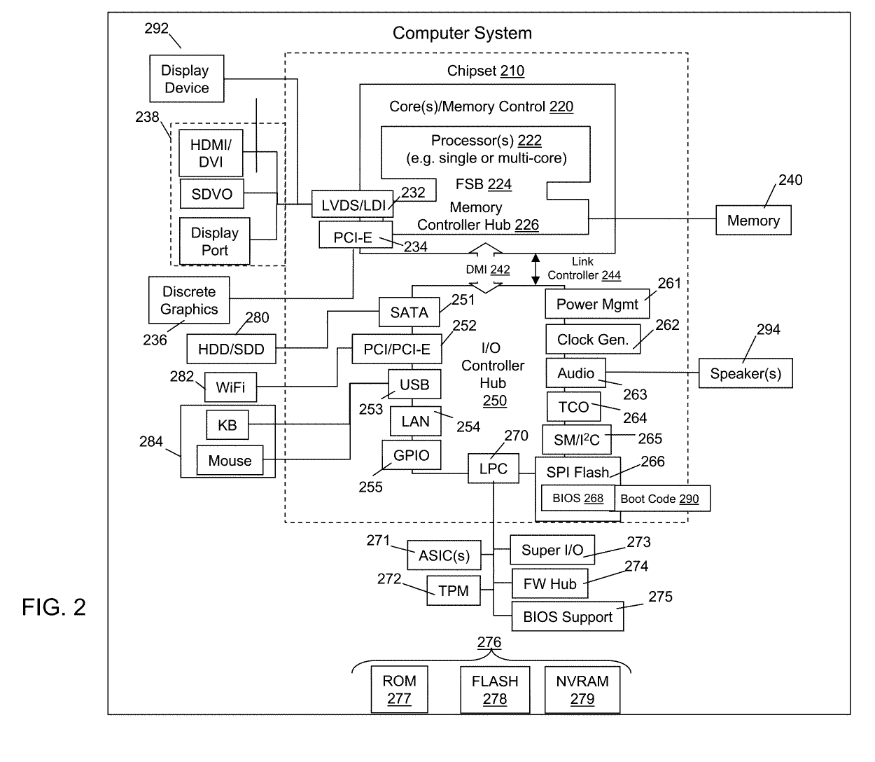

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, near field communication device, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which may run voice processing software and perform actions associated with voice commands. Alternatively or additionally, such devices may be used to detect movements associated with a user speaking. For example, the circuitry outlined in FIG. 1 may be implemented in a tablet or smart phone embodiment, whereas the circuitry outlined in FIG. 2 may be implemented in a personal computer embodiment.

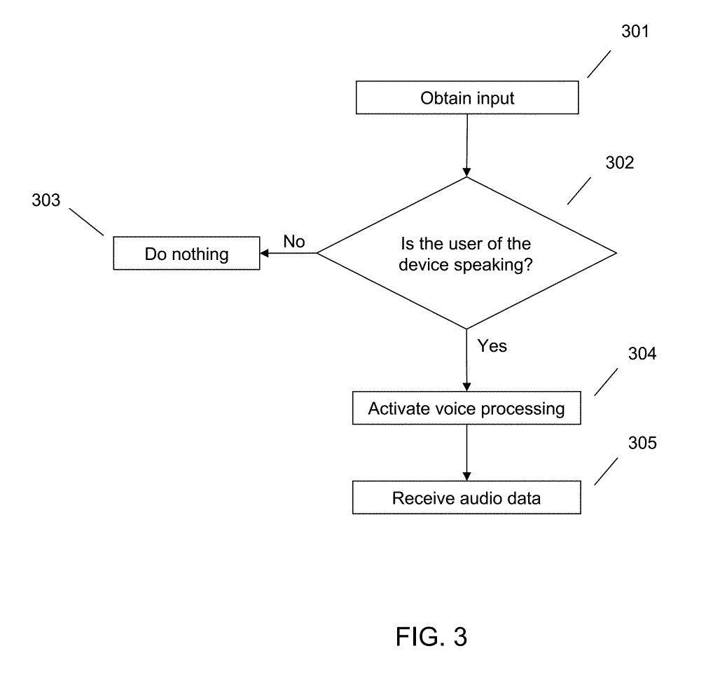

Referring now to FIG. 3, at 301, an embodiment may obtain an input from a device physically located on or touching a user (e.g. headset, smart watch, mobile device touching the user, a device implanted in a user, sensor, etc.). The device may be as simple as a sensor or may include more complex processing capabilities as in an information handling device. For ease of reading, the terms information handling device and device may be used interchangeably, but information handling device does not necessarily mean that a device without processing capabilities is excluded. In one embodiment, the obtaining may comprise using the device to detect the input. In other words, a sensor or other detection mechanism on an information handling device physically located on or touching the user may be used to detect the input. In an additional or alternative embodiment, the obtaining may comprise receiving the input from a second device.

The input may indicate that the user is speaking. In one embodiment, the input may be related to a movement of the user. For example, the input may comprise a signal which may include actual movement data which may then be processed by the receiving device. Alternatively, the input may comprise a signal containing instructions for performing an action based upon the movement. For example, the signal may comprise a high/low signal which may turn a particular bit on/off upon reception of movement data. These examples are intended to be just examples and non-limiting. As is known to one skilled in the art, the input could be a variety of inputs and could contain a variety of information.

The data related to a movement of a user may be captured from any type of data used to determine a user is speaking. One embodiment may use data derived from electromyography to determine that the user is speaking. Electromyography is used to detect muscle movements or nerve simulation when cells are electrically or neurologically activated. Due to the difference of which muscles and nerves are used for different movements, an embodiment may be able to use the electromyography data to determine which cells have been activated, thereby allowing an embodiment to determine the difference between a user moving and a user talking. For example, a user may have a smart watch with a sensor (e.g. electrode, electrical sensor, wire, other device that can detect electrical potential, etc.) that can detect muscle movements or electrical signals produced when the user is speaking.

In an additional or alternative embodiment, the data may be derived from vibration. For example, a device may be equipped with a vibration sensor that can detect when the person is talking. The device may be located in such a location that it can determine when the person is speaking. For example, a user may have a headset which may detect the vibration created when a person is speaking. An additional or alternative embodiment may use a bone-conductive microphone or sensor which may capture bone vibrations to determine that the user is speaking.

If, at 302, it is determined that the user on which the device is physically located is not speaking, an embodiment may do nothing at 303. If, however, the user is speaking, an embodiment may activate voice processing at 304. This activation does not necessarily mean that the device performs a specific action, but rather that the device may just start listening for a voice command to perform an action. The activating of the voice processing may be based upon receiving a particular word or phrase. For example, a device may be set up to activate voice processing upon receiving a particular word or phrase. Alternatively or additionally, voice processing may be activated whenever the user is speaking. A device may then, after activating voice processing, perform an action upon receiving a recognized or associated command.

In one embodiment, the voice processing may not be activated until an embodiment determines that the user is associated with the information handling device. For example, an embodiment may identify the particular user who is speaking. This identification may be accomplished using known identification methods. For example, an embodiment may use voice recognition data to match the voice to an associated user. As another example, an embodiment may use another sensor and/or input device on the device (e.g., image capture device, biometric capture device, etc.) to identify the user.

In one embodiment, the activation of the voice processing at 304 may comprise sending a signal to a second information handling device to activate voice processing. For example, a headset may send a signal to a smart phone with instructions to activate the voice processing on a personal computer based upon the headset detecting the user is speaking. In addition to sending the activation signal, the device may send audio data to the second information handling device. Expanding on the example above, the headset may capture audio data received after activating the voice processing and send this information or a subset of this information to the personal computer. Conversely, the activation may comprise receiving a signal from a second information handling device which may then be used to activate the voice processing. Alternatively, the activation of the voice processing may be based upon receiving a signal from the information handling device which does the voice processing. For example, a tablet may have a sensor that detects that a user is speaking and may then activate voice processing on the tablet.

In other words, the detection and voice processing may be done using one or more devices. When using multiple devices the devices may be operatively coupled together, for example, using a near field communication protocol. Alternatively or additionally, the devices may be associated with each other, for example, electronically paired together, paired together using a network connection, associated using user credentials, and the like. Alternatively, the multiple devices may be wired together. For example, a headset may be plugged into an information handling device having voice processing capabilities.

After activating the voice processing at 304, an embodiment may, at 305, receive audio data. An embodiment may analyze and process this audio data to determine if it should perform an action. For example, once the voice processing has been activated an embodiment may start listening for recognized commands. Upon receiving a recognized command, an embodiment may perform the actions associated with fulfilling that command. For example, a device may detect that a user is speaking. Up to this point, the device has not been processing or analyzing any noise occurring in the environment. Upon detecting that the user who is physically touching the device is speaking, the device may activate the voice processing. The device may then start receiving and processing and analyzing the audio data. If the device recognizes a command within the audio data, the device may perform the actions associated with that command.

The various embodiments described herein thus represent a technical improvement to current voice processing schemes in that an embodiment provides a method of activating voice processing only when it is determined that the user physically touching the device is speaking. Using the techniques described herein, a user does not have to provide a manual input to activate voice processing, thereby increasing the effectiveness and usability of the voice processing capabilities of a device. Additionally, a device having voice processing capabilities does not have to continually run voice processing and does not have to analyze all noises that it receives, thereby reducing the consumption of processing power and battery.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.”

Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
obtaining, from a device physically located on a user, an input indicating the user is speaking;
the input being related to a movement of the user, wherein the movement is caused by the user speaking; and
activating, using a processor, voice processing.

2. The method of claim 1, wherein the input comprises data derived from electromyography.

3. The method of claim 1, wherein the input comprises data derived from vibration.

4. The method of claim 1, wherein the activating comprises sending, to a second device, an instruction to activate voice processing.

5. The method of claim 4, further comprising transmitting audio data to the second device.

6. The method of claim 1, wherein the obtaining comprises receiving the input from the device.

7. The method of claim 1, wherein the device comprises an information handling device and the obtaining comprises detecting the input using the information handling device.

8. The method of claim 1, further comprising identifying the user as a user associated with the device.

9. The method of claim 8, wherein the activating comprises activating voice processing based upon the user being identified as associated with the device.

10. The method of claim 1, further comprising receiving audio data.

11. An apparatus, comprising:
a processor;
a memory device that stores instructions executable by the processor to:
obtain an input indicating a user is speaking;
the input being related to a movement of the user, wherein the movement is caused by the user speaking; and
activate voice processing.

12. The apparatus of claim 11, wherein the input comprises data derived from electromyography.

13. The apparatus of claim 11, wherein the input comprises data derived from vibration.

14. The apparatus of claim 11, wherein to activate comprises sending, to a second device, an instruction to activate voice processing.

15. The apparatus of claim 14, wherein the instructions are further executable by the processor to transmit audio data to the second device.

16. The apparatus of claim 11, wherein to obtain comprises receiving the input from the device.

17. The apparatus of claim 11, wherein the device comprises an information handling device and to obtain comprises detecting the input using the information handling device.

18. The apparatus of claim 11, wherein the instructions are further executable by the processor to identify the user as a user associated with the device.

19. The apparatus of claim 18, wherein to activate comprises activating voice processing based upon the user being identified as associated with the device.

20. A product, comprising:
a storage device having processor executable code stored therewith, the code being executable by the processor and comprising:
code that obtains, from a device physically located on a user, an input indicating the user is speaking;
the input being related to a movement of the user, wherein the movement is caused by the user speaking; and
code that activates voice processing.
